(19) United States
(12) Patent Application Publication
(10) Pub. No.: US 2022/0317242 A1
(43) Pub. Date: Oct. 6, 2022

(54) RFID-BASED REMOTE SENSING USING CROSS CIRCULAR POLARIZATION

(71) Applicant: Google LLC, Mountain View, CA (US)

(72) Inventors: Jiang Zhu, Cupertino, CA (US); Xuanke He, Atlanta, GA (US); Wenjing Su, Mountain View, CA (US)

(73) Assignee: Google LLC, Mountain View, CA (US)

(21) Appl. No.: 17/638,476

(22) PCT Filed: Apr. 2, 2020
(86) PCT No.: PCT/US2020/026446

§ 371 Date: Feb. 25, 2022

Related U.S. Application Data
(60) Provisional application No. 62/953,802, filed on Dec. 26, 2019.

(51) Int. Cl. G01S 7/02; G01S 13/04; G01S 7/40

(52) U.S. Cl. CPC G01S 7/026; G01S 13/04; G01S 7/40

(57) ABSTRACT

Various arrangements for remote sensing using cross-circular polarization are presented. In some embodiments, an RFID (Radio Frequency Identification) emitter is present that emits circular-polarized RF (Radio Frequency) waves having a first polarization. A circular-polarized passive RFID tag may be present that is configured to receive, modulate, and output circular-polarized RF waves that have a second polarization opposite from the first polarization.

### CROSS REFERENCE TO RELATED APPLICATION

This application claims priority to, and the benefit of, U.S. patent application Ser. No. 62/953,802, filed Dec. 26, 2019, the full disclosure of which is hereby incorporated by reference.

### BACKGROUND

Video cameras are frequently used to detect the activity of a person. For instance, whether a person has performed a gesture or a particular movement can be determined by analyzing video or infrared (IR) captured of the person. However, video and IR can have privacy implications. There may be places, such as within a home, where persons would not feel comfortable having a video camera installed, even if the video is only analyzed locally and not saved. For instance, a video camera installed in a bedroom or bathroom may be unacceptable to many people and their guests. Use of IR may result in a relatively high-resolution “image” of a person being captured and thus may result in similar privacy concerns to video. Embodiments detailed herein can be used to address these and other issues.

### SUMMARY

Various embodiments are described related to a system for remote sensing using cross-circular polarization. In some embodiments, a system for remote sensing using cross-circular polarization is described. The system may comprise an RFID (Radio Frequency Identification) emitter. The RFID emitter may emit circular-polarized RF (Radio Frequency) waves having a first polarization. The system may comprise a circular-polarized passive RFID tag configured to receive, modulate, and output circular-polarized RF waves that may have a second polarization. The first polarization may be opposite the second polarization. The system may comprise an RFID reader. The RFID reader may receive circular-polarized RF having the first polarization.

Embodiments of such a system may include one or more of the following features: the RFID emitter may be installed on a first surface perpendicular to a second surface on which the circular-polarized passive RFID tag may be installed. Circular-polarized RF waves emitted by the RFID emitter may be reflected off a moving object to the circular-polarized passive RFID tag. Modulated circular-polarized RF waves output by the circular-polarized passive RFID tag may be reflected off the moving object to the RFID reader. The moving object may be selected from the group consisting of a person, an animal, and an electrically-conductive object. The circular-polarized passive RFID tag may comprise a spiral antenna. The system may comprise a matching network electrically connected with the spiral antenna. The system may comprise an integrated circuit (IC) electrically connected with the matching network. The IC may modulate circular-polarized RF waves received via the spiral antenna and may cause the spiral antenna to emit modulated circular-polarized RF waves. The system further may comprise an RFID transceiver device that may comprise the RFID emitter and the RFID reader. The RFID emitter and the RFID reader may be distinct devices. The RFID emitter may emit continuous wave (CW) circular-polarized RF waves having the first polarization. The system further may comprise an RFID reflection analysis system. The RFID reflection analysis system may be configured to perform a calibration process to determine a steady-state reflection environment without any moving object present. The RFID reflection analysis system may be further configured to analyze deviations from the steady-state reflection environment to detect motion of a moving object. The moving object may be a person. The RFID reflection analysis system may be further configured to analyze the motion of the moving object to determine a gesture performed by the person. The moving object may be a person. The RFID reflection analysis system may be further configured to analyze the motion of the moving object to determine a health condition of the person.

In some embodiments, a method for remote sensing using cross-circular polarization is described. The method may comprise emitting, by an RFID reader device, circular polarized RF waves having a first circular polarization. The method may comprise receiving, by an RFID tag, circular polarized RF waves having a second circular polarization. The circular polarized RF waves may be emitted by the RFID reader device and reflected off an object. The method may comprise modulating, by the RFID tag, the received circular polarized RF waves having the second circular polarization. The method may comprise emitting, by the RFID tag, the modulated circular polarized RF waves having the second circular polarization. The method may comprise receiving, by the RFID reader device, the modulated circular polarized RF waves having the first circular polarization. The modulated circular polarized RF waves may be emitted by the RFID tag and reflected off the object.

Embodiments of such a method may include one or more of the following features: analyzing, the received modulated circular polarized RF waves having the first circular polarization to detect the object. Analyzing the received modulated circular polarized RF waves may comprise analyzing a received signal strength of the received modulated circular polarized RF waves having the first circular polarization. Analyzing the received modulated circular polarized RF waves may comprise analyzing a phase of the received modulated circular polarized RF waves having the first circular polarization. The method may further comprise performing an action based on analyzing the received modulated circular polarized RF waves. Performing the action based on analyzing the received modulated circular polarized RF waves may comprise determining a gesture has been performed by a person. The method may comprise executing a command in response to the determined gesture. Performing the action based on analyzing the received modulated circular polarized RF waves may comprise determining health data about a person. The method may comprise executing a command in response to the determined health data.

In some embodiments, an apparatus for remote sensing using cross-circular polarization is described. The apparatus may comprise means for emitting circular polarized RF waves having a first circular polarization. The apparatus may comprise means for receiving circular polarized RF waves having a second circular polarization. The circular polarized RF waves may be emitted by the means for emitting circular polarized RF waves and reflected off an object. An apparatus may comprise means for modulating the received circular polarized RF waves having the second circular polarization. The apparatus may comprise means for emitting the modulated circular polarized RF waves having the second circular polarization. The apparatus may comprise means for receiving the modulated circular polarized RF waves having the first circular polarization. The modulated circular polarized RF waves were emitted by the means for emitting the modulated circular polarized RF waves and reflected off the object.

### BRIEF DESCRIPTION OF THE DRAWINGS

A further understanding of the nature and advantages of various embodiments may be realized by reference to the following figures. In the appended figures, similar components or features may have the same reference label.

FIG. 1 illustrates an embodiment of a system for RFID (Radio Frequency Identification) based remote sensing using cross circular polarization.

FIG. 2 illustrates another embodiment of a system for RFID-based remote sensing using cross circular polarization.

FIG. 3 illustrates an embodiment of a circular-polarized passive RFID tag.

FIG. 4 illustrates an embodiment of a matching network of a circular-polarized passive RFID tag.

FIG. 5 illustrates an embodiment of a method for RFID-based remote sensing using cross circular polarization.

FIG. 6 illustrates an embodiment of a method for calibrating RFID-based remote sensing using cross circular polarization.

### DETAILED DESCRIPTION

An RFID (Radio Frequency Identification) emitter, RFID reader, and an RFID tag may be used to detect the presence and motion of an object within an environment. Further, since such a system does not involve a camera and involves reflected RF from which a detailed image of the environment and objects within the environment cannot be reconstructed, the use of the system may not meaningfully compromise privacy. For instance, a person may be comfortable having such a system installed in the person's home's bedroom, bathroom, or other room in which a person typically expects privacy since the system does not capture any video or other visual characteristics of persons present in the environment.

In embodiments detailed herein, an RFID emitter may be installed in an environment (e.g., a room) and emit circular-polarized RF (Radio Frequency) waves into the environment. The circular-polarized RF waves have a first circular polarization, which can be either left-hand or right-hand circular polarization. An RFID tag may be installed in the environment in which the RFID emitter is installed, such as on a perpendicular surface to the RFID emitter. The RFID tag may be configured to receive circular-polarized RF having the opposite circular polarization as the RF waves emitted by the RFID emitter. Therefore, the RFID emitter and the RFID tag have cross-circular polarizations. For example, if the RFID emitter emits left-hand circular-polarized RF waves, the RFID tag may be configured to receive right-hand circular-polarized RF waves.

When circular-polarized RF waves are reflected by an object, the circular-polarization reverses. Therefore, circular-polarized-RF having a first circular-polarization as emitted by the RFID emitter will have a second, opposite circular-polarization when received by the RFID tag if the emitted RF waves were reflected a single time by an object before being received by the RFID tag. By the RFID tag being configured to receive the opposite circular polarization of the RFID emitter, the RFID tag is configured to receive RF waves originating from the RFID emitter that have been reflected once (or some other odd number of times).

The RFID tag may be passive, meaning it does not have a power source. Such a passive RFID tag may receive, modulate, and re-emit received, modulated RF waves. The RFID tag may emit modulated RF waves having the same polarization as was received by the RFID tag. Therefore, the RF waves emitted by the RFID tag may be the opposite polarization from the RF waves emitted by the RFID emitter.

The modulated RF waves emitted by the RFID tag may be reflected, such as by the same object as the first reflection, and may again have their circular-polarization reversed. The RF waves may now be in the original polarization as emitted by the RFID emitter. The reflected modulated RF waves may be received by an RFID reader that is configured to receive circular-polarized RF waves having the same circular polarization as emitted by the RFID emitter. In some embodiments, a single RFID reader device can emit and receive the RF waves having the first circular polarization.

Such a system may include an RFID reflection analysis system. The RFID reflection analysis system may perform a calibration process to determine a steady-state reflection environment (signal strength and/or phase at various frequencies). After calibration, when a moving object, such as a person, animal, or other at least partially electrically-conductive object, is present within the environment, the variations in measured RF waves modulated by the RFID tag as received by the RFID reader may be analyzed to determine properties of the moving object. For instance, if the moving object is a person, a gesture performed by the person may be determined. Additionally or alternatively, the size of the moving object may be determined, the position of the moving object may be determined, the amount of movement of the moving object may be determined, or various other health-related data, such as breathing rate may be determined. Since the amount of movement of the moving object may be determined, it may be possible to determine related health-related data about the moving object, such as how much a person has walked (or otherwise moved) within the environment.

Circular polarization may have significant benefits over linear polarization for the purposes detailed herein. For detection of movement of an object within a physical environment, the use of circular polarization may tend to result in greater differences in phase and signal strength than if linearly polarized RF waves are used. Therefore, by using circular polarization, data that may be able to be more accurately analyzed can be obtained.

Notably, embodiments detailed herein do not require any form of RFID tag or equipment to be worn or otherwise carried by the moving object or objects being monitored. Rather, the moving object's natural effect on reflection of circular-polarized RF waves within the physical environment is exploited to allow monitoring without any device being attached with the moving object.

In addition to the description provided below, further details can be found in “RFID Based Non-Contact Human Activity Detection Exploiting Cross Polarization,” published by IEEE on Mar. 6, 2020, ISSN 2169-3536, IEEE Access, Volume 8, pages 46,585-46,595, by X. He et al., the entire disclosure of which is hereby incorporated by reference for all purposes.

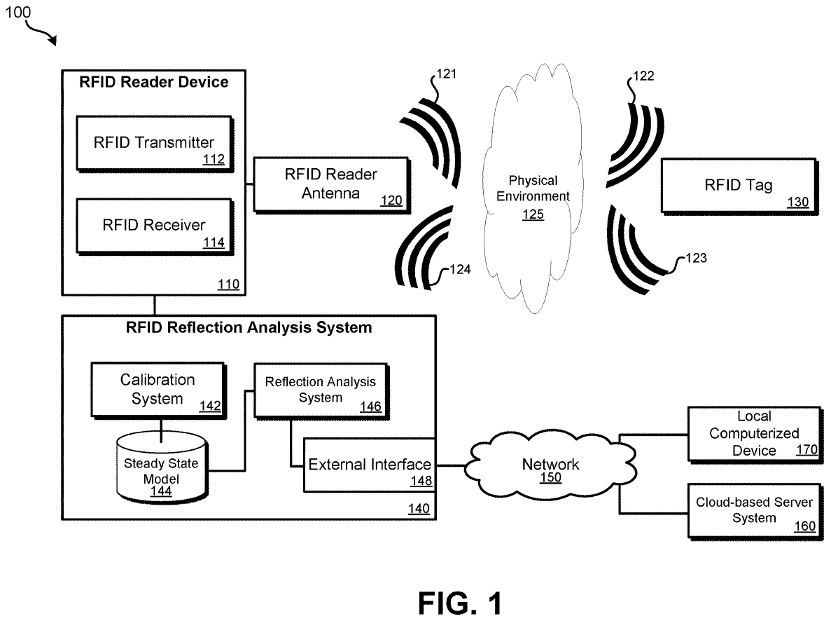

Further detail regarding such embodiments and other embodiments is provided in relation to the figures. FIG. 1 illustrates an embodiment of a system 100 for RFID (Radio Frequency Identification) based remote sensing using cross circular polarization. System 100 can include: RFID reader device 110; RFID reader antenna 120; RFID tag 130; RFID reflection analysis system 140; network 150; cloud-based server system 160; and local computerized device 170.

RFID reader device 110 may include RFID transmitter 112 and RFID receiver 114. In other embodiments, RFID transmitter 112 and RFID receiver 114 may be distinct devices. RFID transmitter 112 may transmit RF waves to RFID reader antenna 120. The RF waves created by RFID transmitter 112 may be continuous wave (CW) RF waves. The RF waves created by RFID transmitter 112 may have circular polarization. Therefore, the RF waves created by RFID transmitter 112 may have either left-hand circular polarization or right-hand circular polarization. The power of the RF waves created by RFID transmitter 112 may be determined based upon the size of the physical environment 125 into which the circular-polarized RF waves are to be transmitted.

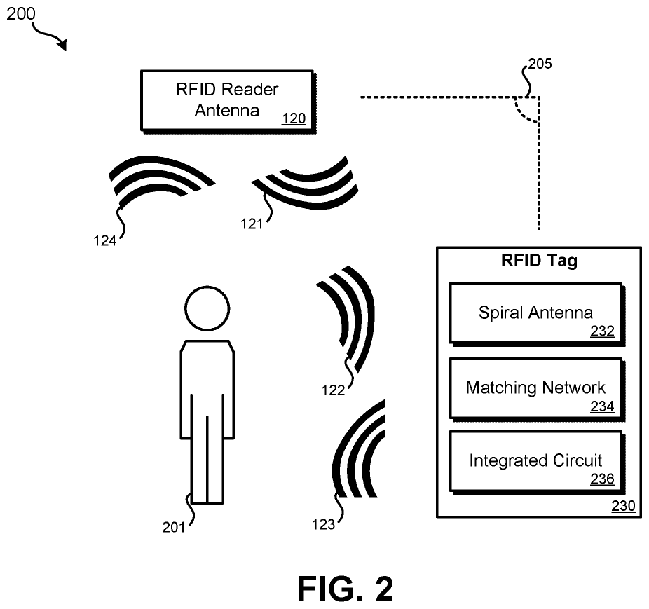

The circular-polarized RF waves may be output into physical environment 125 by RFID reader antenna 120. As illustrated, a single RFID reader antenna 120 is used for RFID transmitter 112 and RFID receiver 114. In other embodiments, RFID transmitter 112 and RFID receiver 114 may have separate antennas. RFID reader antenna 120 may be positioned in physical environment 125 to effectively emit the circular-polarized RF waves throughout physical environment 125. Further detail regarding how RFID reader antenna 120 may be located within physical environment 125 is detailed in relation to FIG. 2. In some embodiments, RFID reader antenna 120 may be incorporated as part of RFID reader device 110. In other embodiments, RFID reader antenna 120 may be separately housed or otherwise may be a separate device that is electrically connected with RFID reader device 110 (or RFID transmitter 112).

RFID reader antenna 120 may output the circular-polarized RF waves having a first polarization (either left-handed or right-handed) into physical environment 125. Notably, when circular-polarized RF waves are reflected by an object, the polarization of the reflected RF waves will be opposite the polarization prior to reflection. Therefore, the RF waves 121 having the first polarization as emitted by RFID reader antenna 120 will have the reverse circular polarization when reflected an odd number of times by objects within physical environment 125. In some embodiments, due to signal strength losses when RF waves are reflected, effectively only RF waves 122 that are reflected once within physical environment 125 may be consequential. RF waves 122 that are reflected three times may have such a low signal strength that they can be effectively ignored.

Reflected RF waves 122 may therefore have a second polarization that is opposite the first polarization. As an example, RFID reader antenna 120 may emit CW RF waves having left-handed circular polarization. An object within physical environment 125, such as a person, may reflect the CW RF waves a single time. These reflected CW RF waves may have right-handed circular polarization.

RFID tag 130 may be passive. A passive RFID tag may not have its own power source. Rather, a passive RFID tag may receive sufficient power to modulate received RF waves from the RF waves themselves. Therefore, a passive RFID tag effectively modulates and retransmits received RF waves. In other embodiments, RFID tag 130 may be active. An active RFID tag may have its own power source which can be used to power one or more processors and may be used to amplify a signal output in response to received RF waves.

RFID tag 130 can include an antenna and matching network configured to receive circular-polarized RF waves having the opposite polarization as the RF waves emitted by RFID reader antenna 120. Therefore, RFID tag 130 is configured to only receive RF waves that have been reflected in an odd number of times within physical environment 125 after the RF waves were emitted by RFID reader antenna 120. Effectively, this would mean that the majority of signal strength of reflected RF waves is due to a single reflection within physical environment 125. Since RFID tag 130 is configured to receive circular-polarized RF waves having the opposite polarization as the RF waves emitted by RFID reader antenna 120, RFID tag 130 effectively filters out RF waves that were not reflected at least once within physical environment 125. Further detail regarding the structure of RFID tag 130 is provided in relation to FIGS. 2-4.

RFID tag 130 may receive, modulate, and retransmit reflected RF waves back into physical environment 125 as modulated RF waves 123. Modulated RF waves 123 may have the same circular polarization as RF waves 122. Therefore, modulated RF waves 123 have the opposite circular polarization of RF waves 121 as emitted by RFID reader antenna 120. Modulated RF waves 123 may be reflected one or more times off one or more objects within physical environment 125. Modulated RF waves 123 that are reflected an odd number of times may result in polarization being reversed again to the original, first polarization of RF waves 121. Therefore, reflected modulated RF waves 124 may have the same polarization as the originally transmitted RF waves 121. While reflected modulated RF waves 124 may have been reflected an odd number of times within physical environment 125, due to attenuation involved in reflections, the majority of signal strength of reflected modulated RF waves 124 are RF waves that have been reflected a single time within physical environment 125.

Reflected modulated RF waves 124 may be received by RFID reader antenna 120 and RFID receiver 114. Reflected modulated RF waves 124 may have the same circular polarization as RF waves 121 that were emitted by RFID reader antenna 120. Therefore, RF waves output by RFID tag 130 that are not reflected at least once in physical environment 125 may effectively be filtered out and ignored by RFID reader antenna 120. As previously detailed, rather than using RFID reader antenna 120, RFID receiver 114 may use a separate antenna for receiving reflected modulated RF waves 124. Data based on reflected modulated RF waves 124 may be output by RFID receiver 114 to RFID reflection analysis system 140 for analysis.

RFID reflection analysis system 140 may include one or more processors and/or one or more non-transitory processor readable mediums in some embodiments. Such processors may include one or more special-purpose or general-purpose processors. Such special-purpose processors may include processors that are specifically designed to perform the functions detailed herein. Such special-purpose processors may be ASICs or FPGAs which are general-purpose components that are physically and electrically configured to perform the functions detailed herein. Such general-purpose processors may execute special-purpose software that is stored using one or more non-transitory processor-readable mediums, such as random access memory (RAM), flash memory, a hard disk drive (HDD), or a solid state drive (SSD). In system 100, RFID reflection analysis system 140 is locally connected with or integrated with RFID reader device 110. In other embodiments, data output by RFID reader device 110 may be transmitted via a network, such as network 150, to RFID reflection analysis system 140, which is located remote from RFID reader device 110.

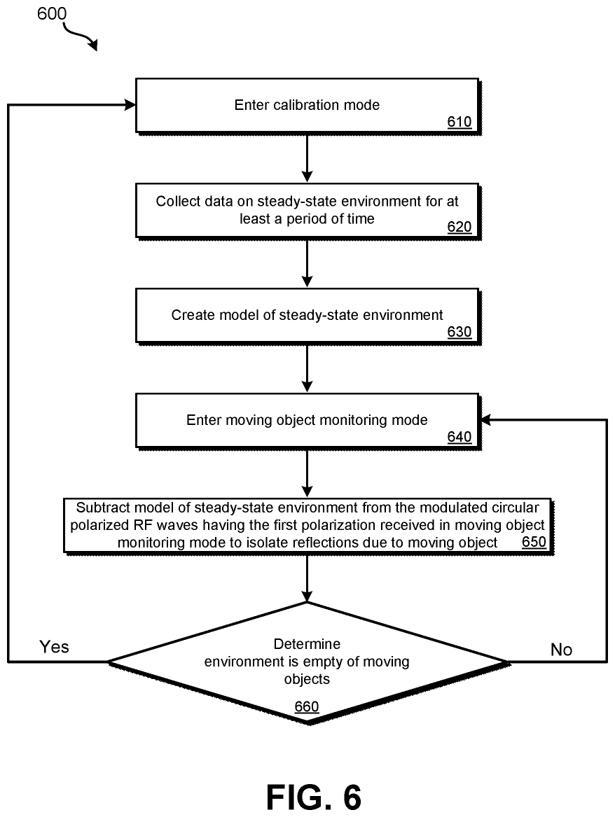

RFID reflection analysis system 140 can include multiple components, including: calibration system 142; steady-state model 144; reflection analysis system 146; and external interface 148. Calibration system 142 may be used to create a steady-state model 144 that is indicative of the RF waves reflected within physical environment 125 when no moving object is present. Steady-state model 144 can include signal strength (e.g., received signal strength indicator, “RSSI”) measurements and phase measurements based on the reflected modulated RF waves 124 received by RFID reader antenna 120. Measurements gathered over a period of time by calibration system 142, while physical environment 125 is in a steady-state may be used to create steady-state model 144. Steady-state model 144 may be stored locally as part of RFID reflection analysis system 140 or may be stored remotely accessible via network 150, such as stored at cloud-based server system 160. Further detail regarding the creation and storage of steady-state model 144 is detailed in relation to FIG. 6.

Reflection analysis system 146 may be used to analyze received data from RFID reader device 110 while one or more moving objects are present within physical environment 125. Reflection analysis system 146 may effectively subtract (or otherwise use) steady-state model 144 from the received data obtained from RFID reader device 110. By doing so, reflection analysis system 146 can identify changes in signal strength (e.g., RSSI) and/or phase (as discussed in relation to Equation 1) due to the presence and/or motion of the moving object within physical environment 125. From these changes in signal strength and/or phase, reflection analysis system 146 can determine gestures performed by the moving object and/or health-related data of the moving object. As an example, gestures that might be able to be detected (when the moving object is a person) can include: hand waving; clapping; crossing of arms; head shaking; and head nodding. Health data (or healthcare data) that can be detected (when the moving object is a person or animal) can include: breathing; heart rate; amount of activity (motion); fall detection; time spent sifting; time spent moving; time spent standing; time spent exercising, etc. Another possible use is for security reasons, such as to detect an unauthorized presence of a person in a physical environment.

External interface 148 may be used to output indications of gestures and/or health data determined by reflection analysis system 146. In some embodiments, external interface may additionally or alternatively output changes in signal strength and/or phase due to the presence and/or motion of the one or more moving objects within physical environment 125. This data may then be analyzed remotely by another system or device. For example, such data may be output through network 150 to local computerized device 170 and/or cloud-based server system 160. For example, cloud-based server system 160 may receive indications of the gestures, physical activity, and/or signal strength and/or phase measurements due to the one or more moving objects and may store such data and/or analyze it. For example, in some embodiments, cloud-based server system 160 may perform the determinations of whether any gestures were performed and/or create health data.

Similar functions may also be performed by local computerized device 170. For example, local computerized device 170 may be a home automation or health data hub that includes a user interface that allows a user to perform various functions. For example, local computerized device 170 may be a home assistant device that can respond to inquiries and gestures and obtain information from one or more remote cloud-based server systems. Local computerized device 170 may also be a device such as: a computer system; a server system; a tablet computer; a smartphone; a gaming device; a laptop computer; etc.

Network 150 may include one or more public and/or private networks. For example, network 150 can include the Internet. Network 150 can also include a private local area network such as a wireless local area network (WLAN).

FIG. 2 illustrates an embodiment of a system 200 for RFID-based remote sensing using cross circular polarization. System 200 can represent a physical arrangement of various components of system 100 of FIG. 1. System 200 can be installed in various physical environments. For example, system 200 can be installed in a room to monitor moving objects present within the room. Similar systems may be installed in each room if movement is to be monitored across multiple rooms. In some situations it may be possible to install multiple systems within a large room to obtain more complete coverage. In addition to rooms, system 200 can be installed in other forms of locations, such as: gymnasiums; outdoor venues; sporting fields; racetracks; patios; etc.

In system 200, a single moving object is present within the physical environment. Person 201 is present. In other embodiments, other forms of moving objects may be present. For example, other forms of moving objects can include animals. Moving objects may be any form of conductive moving object that is capable of reflecting RF waves. For example, a ball that is partially conductive may be monitored within the physical environment using system 200.

In system 200, RFID reader antenna 120 may be installed perpendicularly (as indicated by angle 205) to RFID tag 230 to output RF waves 121 and receive reflected modulated RF waves 124. In some embodiments, this means that RFID reader antenna 120 is attached with a surface that is perpendicular to another surface to which RFID tag 230 is attached. For example, RFID reader antenna 120 may be attached to a ceiling of the room. RFID tag 230 may be attached to a wall of the same room. As another example, the locations of RFID reader antenna 120 and RFID tag 230 can be reversed. As a third example, RFID reader antenna 120 may be affixed to a first wall of the room and RFID tag 230 may be affixed to a second wall of the room that is perpendicular to the first wall.

In this context, “perpendicular” is an approximate term. The walls and ceilings of many buildings are not quite perpendicular. The closer the angle is to perpendicular, the better system 200 may function. Generally, “perpendicular” in the context detailed above can be understood to be an angle between 70° and 110°.

In some embodiments of system 200, perpendicular installation of RFID reader antenna 120 and RFID tag 230 is not needed. Rather, RFID reader antenna 120 and RFID tag 230 may be installed in some other physical arrangement with respect to each other. For example, RFID reader antenna 120 and RFID tag 230 may be attached with the same surface or opposite surfaces within a room or other location where the physical environment is to be monitored.

Further detail with regard to an embodiment of an RFID tag is presented in FIG. 2. RFID tag 230 can represent an embodiment of RFID tag 130. RFID tag 230 can include: spiral antenna 232; matching network 234; and integrated circuit 236. Spiral antenna 232 may tend to be broadband and have a constant impedance across a wide range of frequencies. Spiral antenna 232 may be spiraled in a particular direction to be specifically tuned for receiving either left-handed or right-handed circular-polarized RF waves. Spiral antenna 232 may be manufactured onto a single layer of substrate. Spiral antenna 232 may be an Archimedes spiral.

Matching network 234 may be present to match the impedance of spiral antenna 232 to integrated circuit 236. Matching network 234 is designed and arranged to allow the transfer of almost all of the received power from RF waves 122 to be transferred to integrated circuit 236. Matching network 234 can be used such that the reactance of integrated circuit 236 cancels the reactance of spiral antenna 232. Similarly, for power output by integrated circuit 236, matching network 234 allows almost all of the output power from integrated circuit 236 to be transferred to and used to radiate RF waves 123. Matching network 234 may be a T-shaped matching network feed from which both arms of spiral antenna 232 spiral symmetrically outwards.

Integrated circuit 236 may not have any external power source other than received RF waves 122. Integrated circuit 236 may modulate RF waves 122 received by integrated circuit 236 via spiral antenna 232 and matching network 234. Modulated RF waves 123 may then be output from integrated circuit 236 via matching network 234 and spiral antenna 232 into the physical environment.

In some embodiments, it may be possible to use multiple RFID tags, with each RFID tag having unique identifiers relative to each other. This identifier can be modulated into the RF waves output by each RFID tag. In some embodiments, each RFID tag is used to monitor a different portion of a physical environment, such as different areas of a room.

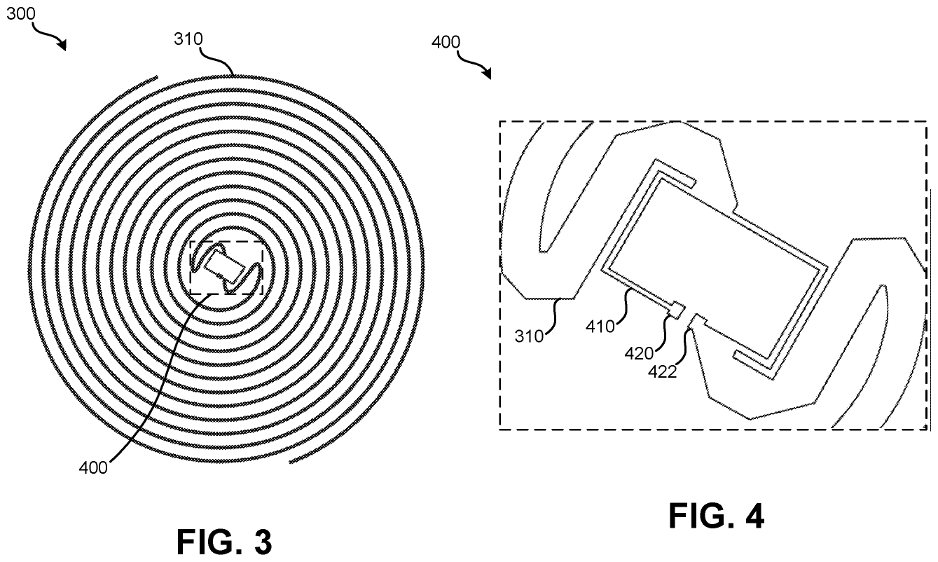

FIG. 3 illustrates an embodiment of a circular-polarized passive RFID tag 300. Spiral antenna 310 represents a possible embodiment of spiral antenna 232. Spiral antenna 310 may be a two-arm spiral. In other embodiments, more arms may be used as part of spiral antenna 310. In some embodiments, a log spiral antenna, such as a two-arm log spiral antenna, may be used. In some embodiments, a lossy cavity may be placed behind spiral antenna 310 to decrease the size of a radiation pattern side lobe that radiates away from the physical environment that is to be monitored. In other embodiments, no such lossy cavity is present.

FIG. 4 illustrates an embodiment of a matching network of a circular-polarized passive RFID tag. FIG. 4 represents an enlarged view 400 of the center region visible in FIG. 3. Matching network 410 may be present to match spiral antenna 310 to an integrated circuit (not visible in FIG. 4.). Matching network 410 can represent an embodiment of matching network 234. An integrated circuit, such as integrated circuit 236, may be electrically connected with matching network 410 at connectors 420 and/or 422. Integrated circuit 236 may be the same or similar to integrated circuits used for a linear-polarized RFID tag, such as a Impinj® Monza® R6 chip.

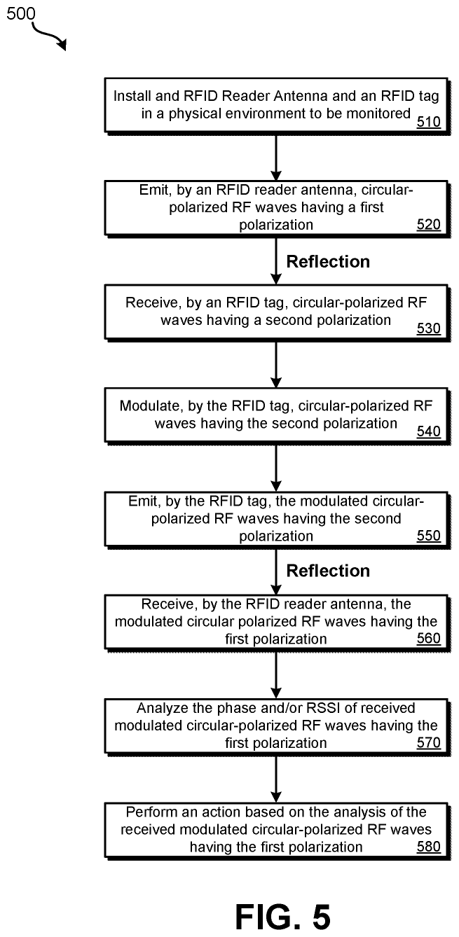

Various methods may be performed using the systems and devices detailed in relation to FIGS. 1-4. FIG. 5 illustrates an embodiment of a method 500 for RFID-based remote sensing using cross circular polarization. Method 500 may be performed using systems 100, and/or 200. Method 500 may also involve use of one or more RFID tags, such as RFID tag 300 of FIG. 3.

At block 510, an RFID reader antenna and an RFID tag may be installed in a physical environment within which one or more moving objects are to be monitored. In some embodiments, multiple RFID tags having unique (compared to each other) identifiers may be installed in a physical environment. In some embodiments, the RFID reader antenna and the RFID tag may be installed with the perpendicular orientation to each other, such as by installing the devices on perpendicular surfaces within a room. In other embodiments, the RFID reader antenna and the RFID tag may be installed in a different orientation such as on opposite ends of the physical environment to be monitored or on the same surface, such as a same wall or ceiling.

At block 520, an RFID reader electrically connected with the RFID reader antenna may emit circular-polarized RF waves that have a first circular polarization. This first circular polarization may be left-handed circular polarization or right-handed circular polarization. The emitted RF waves may be CW RF waves. Prior to block 530 being performed, one or more reflections of the emitted RF waves of block 520 may occur. With each reflection, the circular polarization of the emitted RF waves may reverse. Therefore, after an odd number (e.g., one) of reflections, the circular polarization of the emitted RF waves may be opposite the first circular polarization. The RF waves emitted by the RFID reader antenna may use frequency hopping spread spectrum transmission techniques. This arrangement may help reduce interference with any other RFID readers or other types of devices operating over the same RF frequencies in the area.

At block 530, circular-polarized RF waves having a second polarization that is opposite the first circular polarization may be received by an RFID tag. The RFID tag may be cross-polarized with the RFID reader antenna. Therefore, for example, if the RFID reader antenna emits left-handed circular-polarized RF waves, the RFID tag may be designed to receive circular-polarized RF waves. Accordingly, the RFID tag is configured to receive emitted circular-polarized RF waves that have been reflected an odd number of times (e.g., once) within the physical environment being monitored. As discussed, the RF waves emitted by the RFID reader antenna may use frequency hopping spread spectrum transmission techniques. The spiral antenna of the RFID tag may be broad-spectrum and may be able to effectively receive the frequencies transmitted using the RFID reader.

At block 540, the RFID tag may modulate the received circular-polarized RF waves having the second circular polarization. The RFID tag may be passive or may be active. For a passive RFID tag, an integrated circuit of the RFID tag may function exclusively on the power received via the received RF waves. The modulation by the RFID tag at block 540 can involve an identifier of the RFID tag being encoded into RF waves to be emitted back into the physical environment. The modulation may be performed regardless of the frequency received at block 530 as long as it is within the operating range of the RFID tag.

At block 550, the modulated circular-polarized RF waves may be emitted by the RFID tag back into the physical environment (at the same frequency at which it was received). The modulated circular-polarized RF waves may have the same second polarization as was received by the RFID tag at block 530. Therefore, the polarization of the RF waves emitted by the RFID tag are opposite the polarization of the RF waves emitted by the RFID reader antenna. Prior to block 560 being performed, one or more reflections of the emitted modulated RF waves of block 550 may occur. With each reflection, the circular polarization of the emitted modulated RF waves may reverse. Therefore, after an odd number (e.g., one) of reflections, the circular polarization of the emitted modulated RF waves may be opposite the second circular polarization.

At block 560, circular-polarized modulated RF waves having the first polarization that is opposite the second circular polarization may be received by the RFID reader antenna. Therefore, for example, if the RFID tag emits right-handed circular-polarized modulated RF waves, the RFID reader antenna may be designed to receive left-handed circular-polarized RF waves. Accordingly, the RFID reader antenna is configured to emit and receive RF waves having the same circular polarization.

At block 570, received circular-polarized RF waves having the first polarization may be analyzed to isolate RF waves that have been modulated by the RFID tag. Other RF waves having the first polarization may be discarded. Further, at block 570, the phase (as compared to the transmitted RF waves of block 520 or some other reference) and/or signal strength (e.g., RSSI) of the modulated circular-polarized RF waves having the first polarization may be analyzed.

At block 580, one or more actions may be performed based on the analysis of block 570 that was based on the received modulated circular-polarized RF waves having the first polarization. For example, the action of block 580 may be detecting a gesture and/or executing a command in response to determining that the gesture has been performed by a moving object (e.g., a person) in the physical environment being monitored. As another example, detection of a presence of a type of moving object (e.g., a person) can result in a command being executed. As another example of an action to be performed at block 580, data may be recorded indicative of the health of the moving object, such as how much the moving object has been moving or whether the moving object has fallen. As another example of an action that may be performed, an alert may be transmitted to an administrator indicative of a condition related to the health of the moving object.

While method 500 may be used to obtain measurements of phase and signal strength of reflected modulated circular-polarized RF waves in a physical environment, a model of the static physical environment may need to be constructed to allow changes in signal strength and/or phase due to a moving object to be isolated. A steady-state model of the physical environment with no moving objects present needs to be established to be able to effectively identify changes in signal strength and phase due to the presence and motion of the moving object. FIG. 6 illustrates an embodiment of a method for calibrating RFID-based remote sensing using cross-circular polarization. Method 600 may be performed using systems 100, and/or 200. Method 600 may also involve use of one or more RFID tags, such as RFID tag 300 of FIG. 3. Method 600 may be performed in combination with method 500 of FIG. 5.

At block 610, a calibration mode may be entered by the RFID reflection analysis system, such as RFID reflection analysis system 140. The calibration mode may only be entered when no moving object is present within the physical environment being monitored. In some embodiments, a user may manually set the RFID reflection analysis system to calibration mode. Additionally or alternatively, another device may provide input indicating that no moving object is present and that the calibration mode can be entered by the RFID reflection analysis system. Alternatively or additionally, based upon reflected modulated RF waves being received that have little change in signal strength and/or phase, RFID reflection analysis system 140 can make an assumption that no moving object is present.

At block 620, data may be collected on the steady-state environment for at least a period of time according to method 500. The measured signal strength and/or phase of reflected modulated RF waves may vary significantly based on frequency and the frequency output by the RFID reader may vary significantly due to frequency hopping. Therefore, enough data must be collected at block 620 for all frequency channels that are to be emitted by the RFID reader into the physical environment. As an example, if there are 50 possible channels through which frequency hopping occurs, signal strength and phase data for the steady-state model may be saved for each of these frequency channels. Therefore, the time period for which data is collected at block 620 must be long enough such that data is collected for each frequency channel. At block 630, a steady-state model may be created for the physical environment while it is in a steady-state. The steady-state model indicates reflected modulated RF signal strength and phase for each frequency channel that is used as part of the frequency hopping scheme of the RFID reader. The steady-state model created at block 630 may be stored locally by the RFID reflection analysis system or may be transmitted to a remote device or cloud-based server system for storage.

At block 640, after the steady-state model has been created at block 630, the calibration mode entered at block 610 may be transitioned to a moving object monitoring mode at block 640. As part of the moving object monitoring mode, method 500 may continue to be performed however block 650 may be performed in order to account for the stead-state model created at block 630.

At block 650, the steady-state model of the steady-state environment may be effectively subtracted from the data obtained from the reflected modulated RF waves received by the RFID reader. For signal strength measurements, a difference between the signal strength of the reflected modulated RF waves while a moving object is present and the signal strength on the same frequency channel of the steady state model may be determined. For phase, the analysis may involve, for example, using Equation 1 to determine the change in phase (θ_{c}):

$${θ}_{c} = [ \frac{{f}_{j}}{{f}_{i}} \times ( {θ}_{d , i} - {θ}_{{d}_{0} , i} ) + {θ}_{{d}_{0} , j} ] mod 2 π \qquad Eq \text{.1}$$

In Equation 1, the fixed frequency is denoted as fⱼ and the current measured frequency channel is fᵢ, θ_{d,i} and θ_{d0,j} denotes the saved phase data that is part of the steady-state model for frequency channels i and j. θ_{d0,j} denotes the phase of the RF waves received from the RFID tag at channel j. In this embodiment, the phase measurements on different frequency channels are remapped to a chosen fixed frequency j. The phase is remapped to a frequency which has an initial phase closest to π to give the remapped response a wide range without phase wrapping. θ_{c} is then used as the change in phase due to the presence of the moving object. In other embodiments, the change in change in phase may be calculated differently.

At block 660, a determination may be made as to whether the physical environment is empty of the moving objects that are to be monitored. If empty, the calibration mode may be entered (or remain active). If a determination is made that moving objects are present in the physical environment, method 600 may proceed to block 640 and the moving object monitoring mode may be entered (or remain active).

The methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for remote sensing using cross-circular polarization, the system comprising:
an RFID (Radio Frequency Identification) emitter, wherein the RFID emitter emits circular-polarized RF (Radio Frequency) waves having a first polarization;
a circular-polarized passive RFID tag configured to receive, modulate, and output circular-polarized RF waves that have a second polarization, wherein the first polarization is opposite the second polarization; and
an RFID reader wherein the RFID reader receives circular-polarized RF having the first polarization.

2. The system for remote sensing using the cross-circular polarization of claim 1, wherein the RFID emitter is installed on a first surface perpendicular to a second surface on which the circular-polarized passive RFID tag is installed.

3. The system for remote sensing using the cross-circular polarization of claim 2, wherein:
circular-polarized RF waves emitted by the RFID emitter are reflected off a moving object to the circular-polarized passive RFID tag; and
modulated circular-polarized RF waves output by the circular-polarized passive RFID tag are reflected off the moving object to the RFID reader.

4. The system for remote sensing using the cross-circular polarization of claim 3, wherein the moving object is selected from the group consisting of:
a person;
an animal; and
an electrically-conductive object.

5. The system for remote sensing using the cross-circular polarization of claim 1, wherein the circular-polarized passive RFID tag comprises:
a spiral antenna;
a matching network electrically connected with the spiral antenna; and
an integrated circuit (IC) electrically connected with the matching network, wherein the IC modulates circular-polarized RF waves received via the spiral antenna and causes the spiral antenna to emit modulated circular-polarized RF waves.

6. The system for remote sensing using the cross-circular polarization of claim 1, wherein the system further comprises an RFID transceiver device that comprises the RFID emitter and the RFID reader.

7. The system for remote sensing using the cross-circular polarization of claim 1, wherein the RFID emitter and the RFID reader are distinct devices.

8. The system for remote sensing using the cross-circular polarization of claim 1, wherein the RFID emitter emits continuous wave (CW) circular-polarized RF waves having the first polarization.

9. The system for remote sensing using the cross-circular polarization of claim 1, further comprising an RFID reflection analysis system, configured to perform a calibration process to determine a steady-state reflection environment without any moving object present.

10. The system for remote sensing using the cross-circular polarization of claim 9, wherein the RFID reflection analysis system is further configured to analyze deviations from the steady-state reflection environment to detect motion of a moving object.

11. The system for remote sensing using the cross-circular polarization of claim 10, wherein:
the moving object is a person; and
the RFID reflection analysis system is further configured to analyze the motion of the moving object to determine a gesture performed by the person.

12. The system for remote sensing using the cross-circular polarization of claim 10, wherein:
the moving object is a person; and
the RFID reflection analysis system is further configured to analyze the motion of the moving object to determine a health condition of the person.

13. A method for remote sensing using cross-circular polarization, the method comprising:
emitting, by an RFID reader device, circular polarized RF waves having a first circular polarization;
receiving, by an RFID tag, circular polarized RF waves having a second circular polarization, wherein the circular polarized RF waves were emitted by the RFID reader device and reflected off an object;
modulating, by the RFID tag the received circular polarized RF waves having the second circular polarization;
emitting, by the RFID tag, the modulated circular polarized RF waves having the second circular polarization; and
receiving, by the RFID reader device, the modulated circular polarized RF waves having the first circular polarization, wherein the modulated circular polarized RF waves were emitted by the RFID tag and reflected off the object.

14. The method for remote sensing using cross-circular polarization of claim 13, further comprising:
analyzing, the received modulated circular polarized RF waves having the first circular polarization to detect the object.

15. The method for remote sensing using cross-circular polarization of claim 14, wherein analyzing the received modulated circular polarized RF waves comprises analyzing a received signal strength of the received modulated circular polarized RF waves having the first circular polarization.

16. The method for remote sensing using cross-circular polarization of claim 14, wherein analyzing the received modulated circular polarized RF waves comprises analyzing a phase of the received modulated circular polarized RF waves having the first circular polarization.

17. The method for remote sensing using cross-circular polarization of claim 14, further comprising:
performing an action based on analyzing the received modulated circular polarized RF waves.

18. The method for remote sensing using cross-circular polarization of claim 17, wherein performing the action based on analyzing the received modulated circular polarized RF waves comprises:
determining a gesture has been performed by a person; and
executing a command in response to the determined gesture.

19. The method for remote sensing using cross-circular polarization of claim 17, wherein performing the action based on analyzing the received modulated circular polarized RF waves comprises:
determining health data about a person; and
executing a command in response to the determined health data.

20. An apparatus for remote sensing using cross-circular polarization, the apparatus comprising:
means for emitting circular polarized RF waves having a first circular polarization;
means for receiving circular polarized RF waves having a second circular polarization, wherein the circular polarized RF waves were emitted by the means for emitting circular polarized RF waves and reflected off an object;
means for modulating the received circular polarized RF waves having the second circular polarization;
means for emitting the modulated circular polarized RF waves having the second circular polarization; and
means for receiving the modulated circular polarized RF waves having the first circular polarization, wherein the modulated circular polarized RF waves were emitted by the means for emitting the modulated circular polarized RF waves and reflected off the object.
